(19) United States
(12) Patent Application Publication
(10) Pub. No.: US 2024/0253083 A1
(43) Pub. Date: Aug. 1, 2024

(54) SELF-CLEANING SURFACE SYSTEM AND METHOD OF CLEANING

(71) Applicant: Ioannis EMMANOUILIDIS, Nikaia (GR)

(72) Inventor: Ioannis EMMANOUILIDIS, Nikaia (GR)

(21) Appl. No.: 18/561,166

(22) PCT Filed: Nov. 8, 2021
(86) PCT No.: PCT/GR2021/000066

§ 371 Date: Nov. 15, 2023

Related U.S. Application Data
(60) Provisional application No. 63/190,175, filed on May 18, 2021.

(51) Int. Cl. B08B 1/16; B08B 1/12; B08B 1/30; B08B 3/02; E04B 1/343

(52) U.S. Cl. CPC B08B 1/16; B08B 1/12; B08B 1/30; B08B 3/02; E04B 1/343; B08B 2203/02

(57) ABSTRACT

A self-cleaning surface system, comprising one or more rotatable bodies (19); a support structure (3) supporting the one or more rotatable bodies, wherein the one or more rotatable bodies are configured to rotate with respect to the support structure about a corresponding rotation axis, said one or more rotatable bodies having a corresponding cleanable surface (1) which is parallel to the corresponding rotation axis and being configured to rotate together with the corresponding rotatable body, from facing a first direction to facing a second direction and vice versa, the first direction being opposite to the second direction; a rotation mechanism; a cleaning mechanism comprising a cleaning fluid ejection mechanism; and an activation mechanism, wherein the cleaning fluid ejection mechanism when activated is arranged to eject a cleaning fluid towards said one or more cleanable surfaces when the latter face the second direction.

### TECHNICAL FIELD

The present disclosure concerns a cleaning system, more specifically a self-cleaning surface system. The invention also concerns a method of self-cleaning surfaces of a system. Either said cleaning system or self-cleaning is preferably an automatic one.

### BACKGROUND

Existing cleaning solutions for surfaces require either a person or an external cleaning system (e.g. a cleaning robot). For example, the cleaning procedure of a dirty floor can be done by cleaning personnel, a cleaning robot, or a combination of both. Also, during the cleaning process of that dirty surface, the facility is typically unavailable. In spite the cleaning procedure can be done properly by the cleaning personnel, nothing can ensure the cleanliness of the floor. The next person who will use the clean surface can make it dirty again immediately. The present invention is targeting to all sectors that involve humans or animals and dirty surfaces. The main disadvantages of the known cleaning procedures of surfaces are two. Firstly, surfaces don't automatically clean themselves, and secondly no one can ensure the cleanliness of those surfaces after cleaning personnel or external cleaning systems cleans them.

### SUMMARY OF THE INVENTION

The terminology used herein is for the purpose of describing particular embodiments only and is not intended to limit the invention. As used herein, the term “and/or” includes any and all combinations of one or more of the associated listed items. As used herein, “a”, “an” and “the” are intended to include the plural forms as well as the singular forms, unless the context clearly indicates otherwise. It will be further understood that the terms “comprises” and/or “comprising”, when used in this specification, specify the presence of stated features, steps, operations, elements, and/or components, but do not preclude the presence of addition of one or more other features, steps, operations, elements, components, and/or groups thereof. Unless otherwise is defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein. While describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In accordance with various embodiments, a self-cleaning surface system is provided. There is also provided a method for the self-cleaning surfaces of said system.

The present invention relates to a self-cleaning surface system and the method it follows in order to clean the surface. More particularly, the invention relates to a system that cleans its own dirty surfaces, starting the system either automatically or manually, by using a cleaning mechanism that follows a specific sequence rotating those surfaces. More particularly, the invention relates to a system that can flip over the dirty surfaces into clean ones.

The present invention can be adapted it on a floor, a wall, a kitchen bench top or a food processing bench top, a table or anywhere that we want a clean and disinfected surface constantly. When someone uses the surface and makes it dirty, a controller of the system may give a signal to the motors to flip over the dirty surfaces and brings up the clean ones. By this way the surface may be clean and disinfected and ready for use. The system may operate according to the sequence of rotations it is programmed by, which can be started either automatically or manually.

A first aspect of the invention concerns a self-cleaning surface system, comprising: one or more rotatable bodies; a support structure supporting the one or more rotatable bodies, wherein the one or more rotatable bodies are configured to rotate with respect to the support structure about a corresponding rotation axis, said one or more rotatable bodies having a corresponding cleanable surface which is parallel to the corresponding rotation axis and being configured to rotate together with the corresponding rotatable body, from facing a first direction to facing a second direction and vice versa, the first direction being opposite to the second direction; a rotation mechanism that is configured to rotate the one or more rotatable bodies; a cleaning mechanism comprising a cleaning fluid ejection mechanism; and an activation mechanism configured to activate the cleaning fluid ejection mechanism when each cleanable surface faces the second direction, wherein the cleaning ejection mechanism when activated is arranged to eject a cleaning fluid towards said one or more cleanable surfaces when the latter face the second direction.

The rotatable bodies of the present invention allow rotation of the cleanable surface from facing a first direction, wherein the cleanable surface is in an operational position, to facing a second direction, wherein the cleanable surface is in a cleaning position. When the cleanable surface faces or points towards the first direction, a user can make use of the cleanable surface and the latter may get dirty, whereas when the rotatable body rotates to a position wherein the cleanable surface faces or points towards the second direction, the cleaning mechanism can be activated and the cleaning fluid ejection mechanism proceeds to clean the dirt from the cleanable surface. Afterwards, the rotatable bodies may rotate again, and the cleanable surface may face the first direction and be ready for use after cleaning and/or disinfection. The rotatable bodies can also be named “profiles”.

The rotatable bodies are configured for rotating with respect to the support structure about a corresponding rotation axis. The corresponding rotation axis of each of the rotatable bodies is parallel to the cleanable surface and may be at different distances from the cleanable surface, which may result into different cleanable surface's rotation radius. The support structure corresponds to any structure providing an attachment and support point for the rotatable bodies, wherein the support structure may comprise any other elements that provide a rotatable connection of the profiles.

The cleanable surface of the one or more rotatable bodies is configured in such a way that, when the rotatable body rotates, the cleanable surface can change its position from facing a first direction to facing a second direction and vice versa, wherein the first direction is opposite to the second direction. The rotation between a first position facing the first direction and a second position facing the second direction can be achieved by a 180 degrees rotation.

The rotation mechanism provides motion to the rotatable cleanable surfaces of the rotatable bodies from facing a first direction to facing a second direction. The cleaning mechanism comprises a cleaning fluid ejection mechanism, wherein the latter is configured for ejecting fluid over the one or more cleanable surface that points towards or faces the second direction, i.e., when the cleanable surface is in the second position. The cleaning mechanism may clean simultaneously all the cleanable surfaces of the one or more rotatable bodies or either may clean sequentially the one or more cleanable surfaces. The cleaning fluid ejection mechanism may be configured for pointing towards a fixed area of the cleanable surfaces. The cleaning ejection mechanism may also be movable for pointing to different areas of the cleanable surfaces during the cleaning procedure.

The activation mechanism is configured to activate the fluid ejection mechanism when each of the one or more cleanable surface faces or point towards the second direction, i.e., when the cleanable surface is at the second position. The activation mechanism may comprise any type of sensors such as for instance proximity, pressure, position, touch sensors or others, which may provide a safety mechanism for the users of the self-cleaning surface system, avoiding its operation when any user or obstacle is on top of the cleanable surfaces of the system or in its proximity. The activation mechanism may comprise a controller for establishing and executing a sequence for the cleaning of the cleanable surfaces. The controller may also activate the rotation of the rotatable bodies before or after the cleaning of the cleanable surfaces. In an embodiment, the activation mechanism of the self-cleaning surface mechanism may comprise an injector, wherein the injector is configured to regulate the liquid ejection, and wherein preferably the injector comprises one or more electric valves.

In a preferred embodiment, each rotatable body of the self-cleaning surface system may comprise an additional cleanable surface opposite to the corresponding cleanable surface, wherein the additional cleanable surface may be configured to face the second direction when the corresponding cleanable surface faces the first direction and vice versa, and wherein the cleaning fluid ejection mechanism when activated is arranged to eject the cleaning fluid towards whichever of the cleanable surface of the one or more rotatable bodies faces the second direction. The corresponding cleanable surface of each rotatable body may also be called first cleanable surface and the additional cleanable surface of each rotatable body may be also called second cleanable surface. This configuration may allow to have a second cleanable surface facing the first direction when the first cleanable surface is facing the second direction. In other words, this configuration may allow to have a second cleanable surface readily available to a user of the surface while the cleaning mechanism is cleaning the first cleanable surface. In this way, when the corresponding or first cleanable surface gets dirty, the rotatable bodies may rotate the first cleanable surface from a first position to a second position, moving the second cleanable surface to a second position, i.e., interchanging the positions of the first and second cleanable surfaces. In an embodiment where the self-cleaning surface system is part of a floor, the first cleanable surface may be at the top, followed by the rotatable body, the second cleanable surface and the cleaning system, or if the rotatable body rotates because the first cleanable surface is dirty, the position of the first and second cleanable 20 surface are interchanged, being the second cleanable surface available to be used as a floor while the first cleanable surface is being cleaned.

In an embodiment of the invention, the one or more rotatable bodies may comprise an elongated beam and two flat bodies at distal ends of the rotatable bodies, being the flat bodies parallel to each other. The rotatable bodies, which can also be called profiles, may have a cross section with an I-beam or H-beam shape. The one or more profiles may have any shape or size, as well as being made of any material rigid enough to comply with the purpose of the invention, such as for instance metals alloys or polymeric materials. The flat bodies may comprise a cleanable surface suitable for being cleaned with cleaning fluids or cleaning and disinfecting solutions, or either may be made entirely of a cleanable material suitable for the same purpose.

According to an embodiment, the self-cleaning surface system may comprise a plurality of rotatable bodies arranged adjacent to each other, wherein along a geometrical cross section of each rotatable body, said geometrical cross section being incident and preferably perpendicular to the cleanable surfaces, the rotatable bodies comprise recesses configured to permit the cleanable surfaces of each rotatable body, when the rotatable bodies rotate, to at least partially fit in or pass through the recesses of the adjacent rotatable bodies. That is to say, the cleanable surface of the self-cleaning surface system may be adjacent to each other and arranged to form a continuous cleanable surface, wherein each rotatable body may rotate due to the presence of recesses along a geometrical cross section of the rotatable bodies. The recesses avoid the colliding of a rotatable body with the adjacent rotatable bodies when they rotate. Advantageously, placing cleanable surfaces adjacent to each other may allow to obtain a cleanable surface of higher area while avoiding having excessive gaps between the cleanable surfaces.

In an embodiment, the rotation mechanism of the self-cleaning surface system may further comprise one or more motors configured to rotate the rotatable bodies, and wherein each rotatable body is at a corresponding odd or even position of a sequence of positions, each even position being adjacent to a corresponding odd position of the sequence. The one or more motors may be configured for rotating the rotatable bodies, which may be adjacent to each other. Each of the rotatable bodies may be either at an even or an odd position. The even and odd positions are assigned starting to count sequentially from a first rotatable body to a last rotatable body in the sequence, or vice versa. By way of example, if the self-cleaning surface system comprises seven profiles, there are three rotatable bodies at even positions and four rotatable bodies at odd positions. From this, it can be clearly understood that an even position in the sequence is followed by an odd position and vice versa, unless the odd or even position is at the end of the sequence of positions.

According to another embodiment, the rotation mechanism of the self-cleaning surface system may comprise two motors, wherein one of the two motors is configured to rotate the rotatable bodies which are at the corresponding odd positions and the other motor is configured to rotate the rotatable bodies which are at the corresponding even positions. Therefore, the motors may be configured to provide motion to rotatable bodies at either even or odd positions. This achieves the independent rotation of rotatable bodies, and thus also the cleanable surfaces, at even and odd positions. In other embodiment, the two motors may be configured to rotate first all the rotatable bodies at the corresponding odd positions and then rotate all the rotatable bodies at the corresponding even positions, or vice versa. Consequently, the rotatable bodies may be rotated alternately if desired. Regarding adjacent rotatable bodies, the combination of recesses along a geometrical cross section of each rotatable body, said geometrical cross section being incident and preferably perpendicular to the cleanable surfaces, that permit the rotation of a rotatable body and the alternate rotation of the rotatable bodies, may totally avoid the colliding between adjacent rotatable bodies during the operation of the system. The alternate rotation of the rotatable bodies may be started by first rotating all the rotatable bodies at even positions and then, the rotation of the rotatable bodies at odd positions or vice versa.

In an embodiment, the rotation mechanism may further comprise one or more worm drive mechanisms, wherein the one or more worm drive mechanism may be configured to transmit the motion from the motors to the rotatable bodies. The worm drive mechanism is also known as an endless screw mechanism. The worm drive may comprise a worm, which is a gear in the form of a screw, and a worm wheel, which similar in appearance to a spur gear.

In an embodiment, the rotation mechanism of the self-cleaning surface system may further comprise gears, wherein the gears may be configured to transmit motion from the motors to the rotatable bodies, and preferably the gears being Geneva gears. The Geneva gears, also called Geneva mechanism, may comprise a drive wheel and a driven wheel. The Geneva gears may convert the continuous motion from the motors into a discontinuous motion, which is then transmitted to the rotatable bodies. The rotation of the Geneva gears is preferably performed by sequential 90 degrees rotations. Then, if a 180 degrees rotation is sought to rotate the cleanable surface from facing a first direction to facing a second direction, two sequential and discontinuous rotations of 90 degrees are performed. The system may also work with standard gears and continuous motion of the profiles; however, a locking system for locking the position of rotatable bodies for a better performance of the system may be required. A self-cleaning surface system comprising Geneva gears for transmitting motion from the motors to the rotatable bodies may avoid the use of a locking system for locking the position of the profiles, what means that Geneva gears may lock certain positions of the rotatable bodies during the rotation.

In an embodiment, the self-cleaning surface system may further comprise a transmission chain connected to the gears and configured to transmit the motion from the motors to the gears.

In an embodiment the self-cleaning surface system may further comprise at least one timing belt, wherein the at least one timing belt is connected to the gears and is configured to transmit the motion from the motors to the gears. In another embodiment, the timing belt may distribute the motion from the motors to the rotatable bodies, wherein one timing belt may transmit the motion from a first motor to the rotatable bodies at the even positions and another timing belt may transmit the motion from a second motor to the rotatable bodies at the odd positions. In a further embodiment, the self-cleaning surface system may further comprise belt tensioners and guiding rolls for tensioning and guiding, respectively, the timing belt. The guiding rolls may contribute to distributing more effectively the motion from the motors to the rotatable bodies.

According to an embodiment, the self-cleaning surface system may further comprise one or more axles, wherein the rotatable bodies are attached to the support structure by means of the one or more axles, preferably each rotatable body being attached and rotatable by means of two of the axles. The axles may be used for rotatably connecting the rotatable bodies to the support structure. In an embodiment, each rotatable body may comprise two axles, wherein one of the axles comprises gears that transmit the motion from the motors whereas the other works as a supporting axle.

In an embodiment, the rotation mechanism of the self-cleaning surface system may further comprise bushings or bearings, wherein the axles are attached to the support structure by means of bushings or bearings. The bearings or bushings in this embodiment improve the rotatable connection of the axles, and thus the rotatable bodies, with the structural support. The bushings may be self-lubricating bushings. The bushings or bearings may be inside a socket or holder.

In an embodiment, the support structure of the self-cleaning surface system may be a frame. The frame may be around the rotatable bodies and used for supporting the rotatable bodies. The frame may also be arranged for supporting at least a part of the rotation mechanism and the cleaning mechanism, such as for instance the one or more motors.

In an embodiment, the cleaning fluid may be a cleaning liquid, wherein the cleaning liquid may comprise cleaning or disinfecting agents. In other embodiment, the cleaning fluid may be a steam, wherein the steam may be a steam of water or a steam of water comprising cleaning and/or disinfecting agents.

According to an embodiment, the cleaning ejection mechanism of the self-cleaning surface system may comprise one or more spray nozzles configured to spray the cleaning fluid over the cleanable surfaces that face the second direction, and wherein preferably the cleaning fluid comprises cleaning and/or disinfecting agents. The spray nozzles may be configured pointing towards the one or more cleanable surfaces facing the second direction. The spray nozzles may be arranged at an angle between 0 to 90 degrees with respect to the geometrical plane coincident with the cleanable surface, provided that all the cleaning surfaces of the system are reached by cleaning fluid ejected from at least one of the spray nozzles. The spray nozzles may help to efficiently clean the cleanable surface and distribute the cleaning fluid over the cleanable surface.

In an embodiment, the cleaning mechanism of the self-cleaning surface system may further comprise one or more wipers of the windshield type, which in the present application may simply be called wipers, configured to clean the cleanable surfaces that face the second direction, wherein preferably each wiper is rotatable from 0 to 90 degrees. The wipers may complement and improve the cleaning performed by the cleaning fluid ejection mechanism. The wipers may be configured to contact the one or more surfaces upon rotation and clean the surface from the stubborn dirt. One or more wipers can be used to contact and clean the one or more cleanable surfaces. When more than one wiper is used, the different wipers may actuate alternately.

According to an embodiment, the self-cleaning surface system may further comprise one or more motors connected to the wipers by angular gears and configured to rotate said wipers. In an embodiment, the system may comprise one or more motors connected to the rotatable bodies and one or more motors connected to the wipers by angular gears, being the activation of the motors connected to the wipers independent from the activation of the motors connected to the rotatable bodies. In other embodiments, the one or more motors may be connected to the rotatable bodies and the wipers simultaneously, the motors being arranged for shifting the transmission towards the rotatable bodies or the wipers.

According to an embodiment, the system may further comprise one or more wheel brushes configured to clean the cleanable surface facing the second direction. The wheel brushes may contact the cleanable surfaces facing the second direction. The wheel brushes may be used in combination with a cleaning fluid ejected from the cleaning mechanism.

In an embodiment, the self-cleaning surface system may further comprise a case in which the system fits. The case may encompass the cleaning system and the rotation mechanism, leaving the cleanable surfaces facing the first direction available for their use. The case may be configured for collecting the cleaning fluid or cleaning and disinfecting solutions used for the cleaning of the cleanable surfaces facing the second direction. In another embodiment the case of the self-cleaning surface system may further comprise a floor sink. The floor sink may be configured for the drainage of the cleaning fluid or cleaning and disinfection solution.

In other embodiments, the one or more cleanable surfaces of the self-cleaning surface system may be made of a material selected from the group consisting of ceramic, granite, glass, plexiglass, stone, metal, plastic wood, synthetic, organic or combinations thereof. Any material suitable for being cleaned with cleaning or disinfecting solution may be used in the cleanable surface. In other embodiments, the cleanable surfaces may be made of a hydrophobic material. The hydrophobic material may facilitate the cleaning and drying of the cleanable surfaces.

In an embodiment, the activation mechanism may comprise a controller configured to control the rotation of the profiles and the cleaning mechanism. The controlled may be configured to establish the sequence of steps required for cleaning the cleanable surfaces. In other embodiments, the system may further comprise sensors configured to detect at least one element on the one or more cleanable surfaces facing the first direction. The controller may be configured to receive activation signals by means of sensors installed in the self-cleaning surface system that provide information about the presence of dirt in the cleanable surface facing the first direction, detect de presence of elements on top of the cleanable surface that may cause malfunction of the system and/or gather information determining the end of certain steps of the sequence of steps.

In an embodiment, the self-cleaning surface system may further comprise one or more sensors configured to activate the cleaning of the cleanable surface or the rotation of the rotatable bodies. The sensors may be configured to detect external actions or stimuli that condition the activation or deactivation of the system. In other words, the sensors may be configured to provide signals for either starting or stopping the rotation of rotatable bodies and cleaning of the cleanable surfaces. In an embodiment, the sensors may be photosensors configured to detect one or more light variations caused from at least one element or user on top of the cleanable surfaces. Consequently, if a photosensor detects any light variation caused from at least one element or user on top of the cleanable surface, the system may stop the cleaning procedure and avoid any damage towards the system or the user. In other embodiment, the self-cleaning surface system may further comprise weight sensors configured to sense weight variations cause by at least one element or user on top of the cleanable surfaces. In this embodiment, the sensors may be configured to detect the weight of any element or any user that may be on top of the cleanable surface of the system and use this information as a condition for starting, stopping or continuing the cleaning or rotation of the cleanable surfaces. That is to say, if for example a user is on top of the cleanable surface, the sequence for the cleaning or the rotation of the cleanable surface does not start until the cleanable surfaces are free. In other embodiment, the system may further comprise motion cameras configured to detect at least one element or user on top of the cleanable surfaces. The motion cameras may be configured to record images or videos from the elements or users on top of the cleanable surfaces. This images or videos may be used as a condition for initiating or continuing the cleaning of the cleanable surfaces or the rotation of the rotatable bodies, i.e., the cleaning procedure.

According to an embodiment, the self-cleaning surface system may be configured to be activated manually. The system may be configured to be activated by a user. The user may activate the system by pushing a button of controller, on a remote control or any other element that involves a manual activation of the system. The user may activate the system at convenience; however, the system may also be subject to deactivation caused by detection or sensing of elements on top of the cleanable surfaces, or signals derived from them, that may cause malfunction of the system.

According to another embodiment, the system may be configured to activate the rotation of the profiles and the cleaning of the cleanable surfaces automatically. The cleaning procedure, which comprises the rotation of the rotatable bodies and the cleaning of the cleanable surface, may be activated automatically by the system when it detects by means of sensors that the cleanable surfaces are free from obstacles or users. The system may also be automatically activated when the system detects dirt on the one or more cleanable surfaces, and it detects that the surfaces are free from obstacles or users.

In an embodiment, the self-cleaning surface system may further comprise flat elements around the rotatable bodies, wherein the flat elements cover the rotation mechanism and the support structure. The flat elements may be in the same plane as the cleanable surface of the rotatable bodies facing the first direction, wherein the cleanable surface faces the first direction and the flat elements may be adjacent to each other, i.e., not leaving gaps between them. The flat elements by covering the rotation mechanism and the support structure may provide security to the user and avoid the interaction with elements which may cause damage to the user, such as the motors or gears. The flat elements may comprise a cleanable surface that points the first direction, which cannot rotate and made of the same material than the material of the cleanable surfaces at the rotatable bodies.

A second aspect of the invention concerns a floor comprising a self-cleaning surface system as described in any of the embodiments above.

The invention in its third aspect concerns a method for the self-cleaning of the surfaces of a system as described in any of the embodiments above, the method comprising the steps of: rotating the one or more rotatable bodies 180 degrees from facing a first direction to facing a second direction; activating the cleaning mechanism once all the rotatable bodies face the second direction; and cleaning the one or more cleanable surfaces facing the second direction by ejecting the cleaning fluid towards said one or more cleanable surfaces.

In a preferred embodiment, each rotatable body of the self-cleaning surface system comprises an additional cleanable surface opposite to the corresponding cleanable surface, wherein the additional cleanable surface faces the second direction when the corresponding cleanable surface faces the first direction and vice versa, and wherein the cleaning fluid ejection mechanism when activated ejects the cleaning fluid towards whichever of the cleanable surface of the one or more rotatable bodies faces the second direction. Advantageously, the method allows to interchange the positions of the corresponding cleanable surface and the additional surface, which may be also called first and second cleanable surface, respectively. The cleaning of the first cleanable surface may be performed while having available the second cleanable surface for its use.

In an embodiment wherein the self-cleaning surface system may further comprise a plurality of rotatable bodies and wherein the rotation mechanism further comprises one or more motors configured to rotate the rotatable bodies, and wherein each rotatable body is at a corresponding odd or even position of a sequence of positions, each even position being adjacent to a corresponding odd position of the sequence, the method for the self-cleaning of the surfaces of the system wherein the step of rotating the one or more rotatable bodies 180 degrees from facing a first direction to facing a second direction may be first made over rotatable bodies at the corresponding odd positions and then over profiles at the corresponding even positions or vice versa. If the rotatable bodies at odd positions rotate at a different time that the rotatable bodies at even position the colliding may be avoided.

In an embodiment wherein the cleaning mechanism of the self-cleaning surface system may comprise one or more wipers configured to clean the cleanable surfaces that face the second direction, wherein preferably each wiper is rotatable by 90 degrees, the wherein the step of cleaning the one or more cleanable surfaces facing the second direction by ejecting the cleaning fluid towards said one or more cleanable surfaces may be preceded or followed by a step of rotating the wipers over the cleanable surfaces facing the second direction.

In an embodiment wherein the self-cleaning surface system further comprises sensors configured to detect at least one element on the one or more cleanable surfaces facing the first direction, the method may comprise a first step of detecting at least one element on the surface at the first side.

In an embodiment, the system may automatically start the steps of the method. The steps of the method may be automatically started upon compliance with conditions based on certain parameters detected by sensors, such as for instance, when the system detects that the cleanable surface is free of obstacles or users. In other embodiments, the user of the self-cleaning surface system may manually start the steps of the method.

### BRIEF DESCRIPTION OF DRAWINGS

A further understanding of the nature and advantages of particular embodiments may be realized by reference to the remaining portions of the specification and the drawings, in which like reference numerals are used to refer to similar components. Some preferred embodiments of the invention will now be described with reference to the accompanying drawings, of which:

FIG. 1 is a top view of an embodiment of a self-cleaning surface system according to the invention;

FIG. 2 is a top view of an embodiment of a self-cleaning surface system according to the invention;

FIG. 3A is a partial top view of an embodiment of a self-cleaning surface system according to the invention;

FIG. 3B is a side view of an embodiment of a self-cleaning surface system according to the invention;

FIG. 4A is a partial top view of an embodiment of a self-cleaning surface system according to the invention;

FIG. 4B is a side view of an embodiment of a self-cleaning surface system according to the invention;

FIG. 5 is a rear view of an embodiment of a self-cleaning surface system according to the invention;

FIG. 6A is a top view of an embodiment of a case of a self-cleaning surface system according to the invention;

FIG. 6B is a perspective view of an embodiment of a case of a self-cleaning surface system according to the invention;

FIG. 7A is a side view of a rotatable body of an embodiment of a self-cleaning surface system according to the invention;

FIG. 7B is a side view of eight rotatable bodies of an embodiment of a self-cleaning surface system according to the invention;

FIG. 8A-I are side views of eight rotatable bodies of an embodiment of a self-cleaning surface system according to the invention and depict a sequence of rotation of the rotatable bodies;

FIG. 9A-D are side views of rotatable bodies with different geometry of different embodiments of a self-cleaning surface system according to the invention;

FIG. 10A-E are top views of different embodiments of a self-cleaning surface system comprising one or more rotatable bodies according to the invention.

### DETAILED DESCRIPTION OF EMBODIMENTS

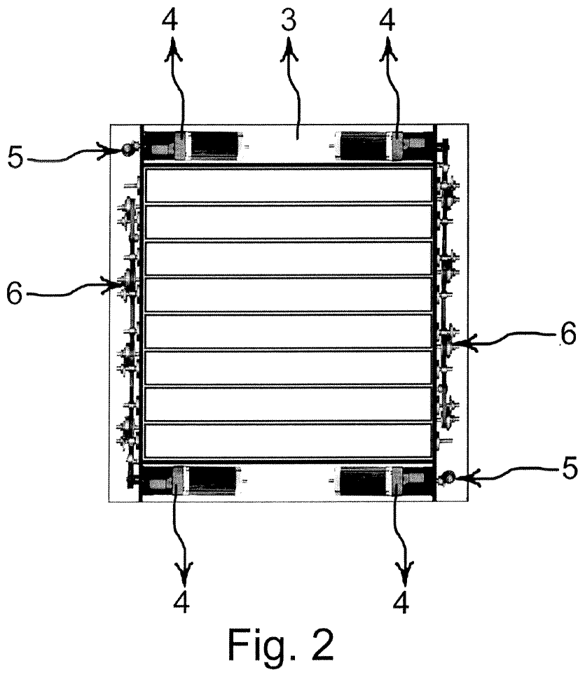

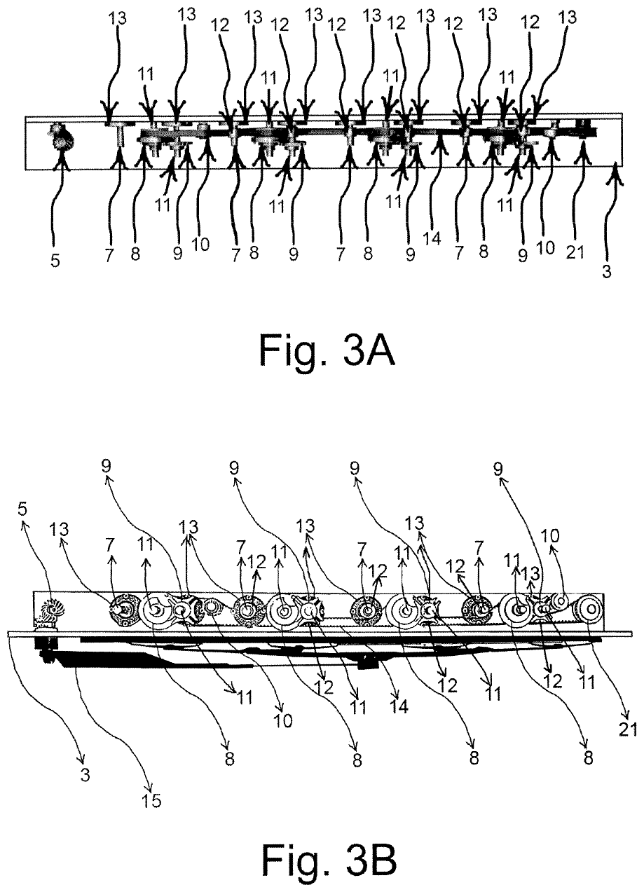

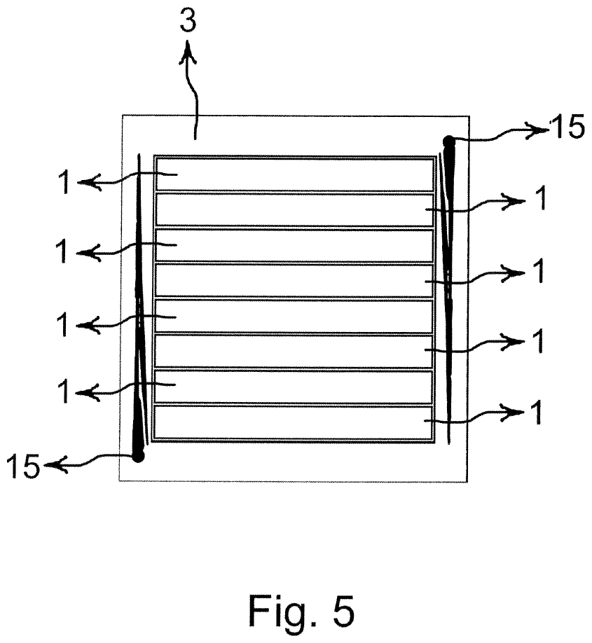

The present invention will now be described by referencing the appended figures representing preferred embodiments. Reference is made to FIG. 2 which depicts a top view of an embodiment of a self-cleaning surface system, according to the present invention. In this embodiment, the self-cleaning surface system comprises eight rotatable bodies 19; a support structure 3, which in this case corresponds to a frame, supporting the rotatable bodies 19, wherein the rotatable bodies 19 are configured to rotate with respect to the support structure 3 about a corresponding rotation axis, said rotatable bodies 19 having a corresponding cleanable surface 1 which is parallel to the corresponding rotation axis and being configured to rotate together with the corresponding rotatable body 19, from facing a first direction to facing a second direction and vice versa, the first direction being opposite to the second direction; a rotation mechanism that is configured to rotate the one or more rotatable bodies 19; a cleaning mechanism, as shown in FIG. 3 and FIG. 5, comprising a cleaning fluid ejection mechanism; and an activation mechanism configured to activate the fluid ejection mechanism when each cleanable surface 1 faces the second direction, wherein the cleaning fluid ejection mechanism when activated is arranged to eject a cleaning fluid towards said one or more cleanable surfaces 1 when the latter face the second direction. In the embodiment, the cleanable surfaces 1 are facing a first direction. Regarding the support structure 3, it is contemplated that it may be different from a frame. In this embodiment, the rotation mechanism comprises two motors 4 configured to rotate the rotatable bodies 19, and wherein each rotatable body 19 is at a corresponding odd (1a, 1c, 1e, 1g) or even (1b, 1d, 1f, 1h) position of a sequence of positions, each even position (1b, 1d, 1f, 1h) being adjacent to a corresponding odd position (1a, 1c, 1e, 1g) of the sequence. However, it is contemplated that only one motor 4 may be configured for rotating the rotatable bodies 19. Similarly, it is contemplated that more than two motors 4 are used to rotate the rotatable bodies 19. The even and odd positions of the rotatable bodies are assigned by starting to count from a first rotatable body 19 to the last rotatable body of the sequence. It is understood that this assignment can be done in the opposite way. In this embodiment, the two motors 4 are configured to rotate the rotatable bodies 19 which are at the corresponding odd positions (1a, 1c, 1e, 1g) and the other motor is configured to rotate the rotatable bodies which are at the corresponding even positions (1b, 1d, 1f, 1h). On this basis, in the embodiment there are four even positions (1b, 1d, 1f, 1h) and four odd positions (1a, 1c, 1e, 1g). Furthermore, the two motors are configured to rotate first all the rotatable bodies at the corresponding odd positions (1a, 1c, 1e, 1g) and then rotate all the rotatable bodies at the corresponding even positions (1b, 1d, 1f, 1h), or vice versa.

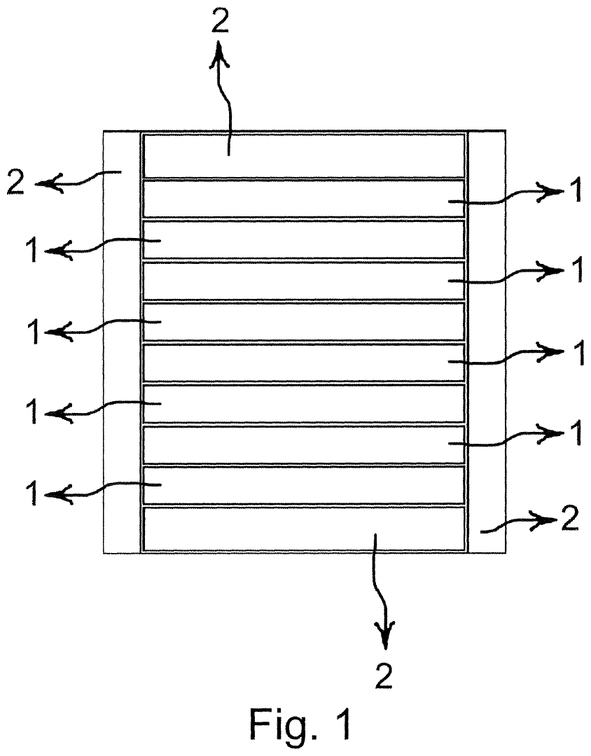

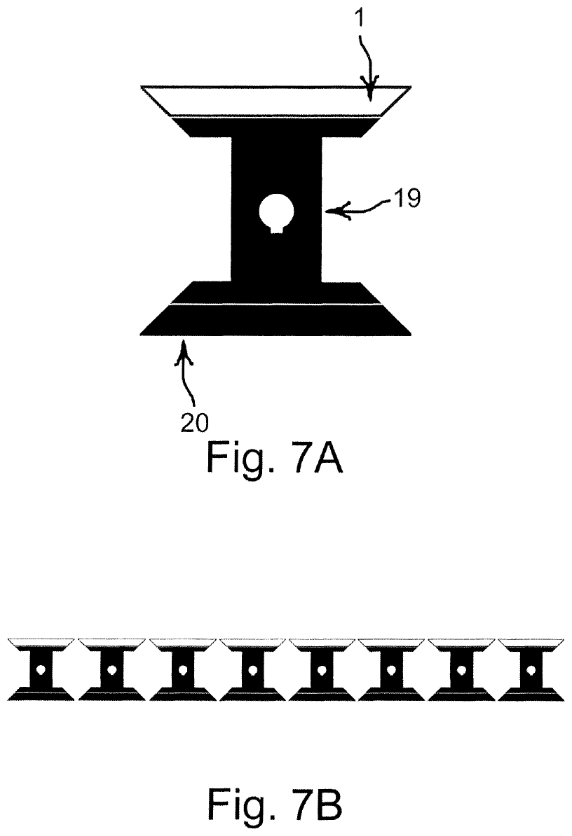

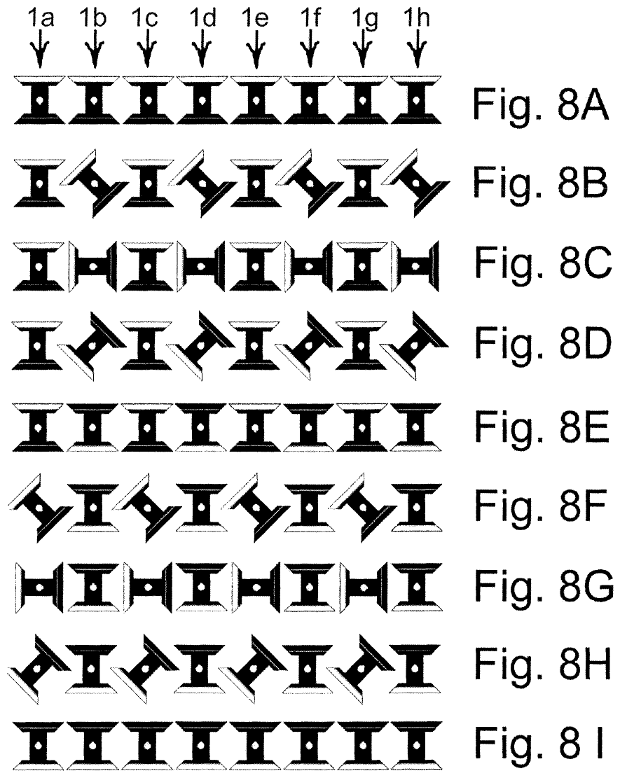

Reference is now made to FIG. 1, wherein a top view of an embodiment of a self-cleaning surface system comprising eight rotatable bodies 19 is depicted. In this embodiment, there are shown eight rotatable bodies 19, each comprising a cleanable surface 1. The structural support 3, rotation mechanism and cleaning mechanism are not shown in FIG. 1 since the system comprises flat elements 2 around the rotatable bodies 19, wherein the flat elements 2 cover the rotation mechanism and the support structure 3. The present invention comprises eight rotatable bodies 19 comprising eight cleanable surfaces 1 that can rotate 360 degrees and four surfaces on flat elements 2 that cannot rotate. The cleanable surfaces can rotate 360 degrees between the positions of the cleanable surfaces facing a first direction and facing a second direction can be achieved by a 180 degree rotation. The rotatable bodies, which can also be called profiles, may comprise flat cleanable bodies or cleanable surfaces 1. Therefore, in other words, the profiles may have surfaces 1 that can be cleaned by the cleaning mechanism of the system. Reference is now made to FIG. 7, wherein it is shown an embodiment of a profile 19 and an embodiment comprising eight identical adjacent profiles. In this embodiments, each rotatable body 19 comprise an additional cleanable surface 20 opposite to the corresponding cleanable surface 1, wherein the additional cleanable surface 20 is configured to face the second direction when the corresponding cleanable surface 1 faces the first direction and vice versa, and thus, in an embodiment of a self-cleaning surface system comprising these profiles 19, the cleaning fluid ejection mechanism when activated is arranged to eject the cleaning fluid towards whichever of the cleanable surface (1 or 20) of the one or more rotatable bodies faces the second direction. Every surface is on a profile 19. So, every profile 19 has one surface 1 on top and one on the bottom 20. Those surfaces can be made with all kinds of material. For example, on a floor can be granite, tile, wood etc. So, all eight profiles in FIG. 7B have one surface on top 1 and one surface on bottom 20. The eight surfaces can flip over 180 degrees during the operation which follow a specific sequence of rotations. Reference is now made to FIG. 8, which depicts a side view of the eight profiles 19 and the sequence of rotation that follows during the operation in an embodiment of the invention. This embodiment comprises a plurality of rotatable bodies 19 arranged adjacent to each other, wherein along a geometrical cross section of each rotatable body 19, said geometrical cross section being incident and preferably perpendicular to the cleanable surfaces 1, the rotatable bodies 19 comprise recesses configured to permit the cleanable surfaces 1 of each rotatable body 19, when the rotatable bodies 19 rotate, to at least partially fit in or pass through the recesses of the adjacent rotatable bodies 19. FIG. 8 is divided in eight lines. FIGS. 8A, 8B, 8C, 8D, 8E, 8F, 8G, 8H and 8 I. The motion of the profiles 19 in this embodiment is performed by rotating first the profiles 19 in an even position (1b, 1d, 1f, 1h) and then the profiles 19 in an odd position (1a, 1c, 1e, 1g), although it is contemplated that the rotation may be made the other way around. FIG. 8A shows the eight profiles 19 without any motion. FIG. 8B, FIG. 8C, FIG. 8D and FIG. 8E shows the profiles 19 in an even position (1b, 1d, 1f, 1h) that flip over 180 degrees and the profiles 19 in an odd position (1a, 1c, 1e, 1g) stay still. The FIG. 8F, FIG. 8G, FIG. 8H and FIG. 8I show the profiles 19 in an odd position (1a, 1c, 1e, 1g) that flip over 180 degrees, and the profiles in an even position (1b, 1d, 1f, 1h) stay still. So, FIG. 8I depicts all surfaces that have flipped over 180 degrees. This is one cycle. The top surfaces 1 flip over 180 degrees following this sequence of rotation, however the opposite sequence of rotation wherein the odd profiles 19 rotate first is also contemplated. When the top surfaces 1 are dirty the automatic system flips over alternate odd and even surfaces 180 degrees till all eight surfaces 1 flip over. So, the dirty surfaces 1 are currently on the bottom side and the clean surfaces 20 come from bottom to the top. When the eight dirty surfaces 1 are on the bottom side, i.e., facing a second direction, the cleaning mechanism starts to clean them and keep them stand by till the next 180 degrees rotation. The present sequence of rotation may be followed to avoid that the surfaces collide each other It is also contemplated that the rotation of all profiles 19 is achieved by following a one by one rotation. One surface rotates and the exact next surfaces remain still etc. In the embodiment of FIG. 8, odd numbers rotate together, and even numbers rotate together. The present invention has eight surfaces that can flip over because it is sought to cover a specific square centimeter area with fixed length, width and height. The system can also operate properly with more than one surface.

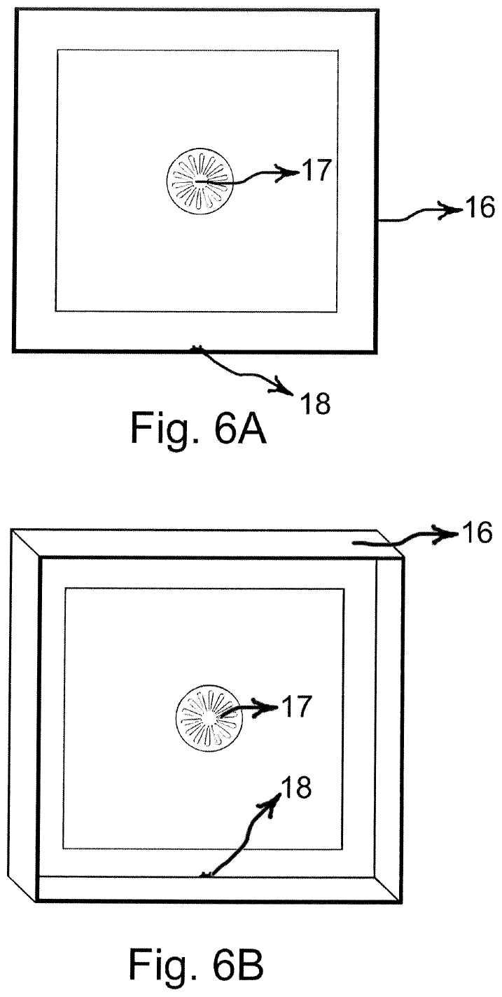

The flat elements 2, and thus its surfaces, in FIG. 1 cannot flip over. Under those four flat elements are the motors 4 and the rotation mechanism of the system. As it shown in the embodiment of FIG. 5, the present invention may comprise a mechanism with motors 4, gears (8, 9), axles (7, 11) and other components that give motion and rotates 180 degrees the eight dirty cleanable surfaces 1 on top following the sequence shown before and bring on top the eight clean cleanable surfaces 20. In the embodiment of FIG. 6, the cleaning ejection mechanism of the system comprises two spray nozzles (18) configured to spray the cleaning fluid over the cleanable surfaces that face the second direction, wherein preferably the cleaning fluid comprises cleaning and/or disinfecting agents. However, it is contemplated that the system may comprise one or more spray nozzles (18). In FIG. 5, the system comprises two wipers (15) of the windshield type configured to clean the cleanable surfaces that face the second direction, wherein each wiper is rotatable by 90 degrees. However, it is also contemplated that the system comprises one or more wipers (15) of the windshield type. The system may also comprise wheel brushes for cleaning the cleanable surfaces. The system comprises two motors 4 connected to the wipers by angular gears 5 and configured to rotate said wipers 15. As shown in FIG. 2, the rotation of the wipers 15 can be done independently. When the dirty surfaces rotate 180 degrees, the cleaning mechanism with wipers (15) of the windshield type or windshield wipers, water with cleaning and disinfecting agent deriving from a windshield wiper spray jet washer nozzle 18, which is shown in FIG. 6, cleans them and keeps them clean and stand by till the next 180 degrees rotation. FIG. 2 depicts the top view of the system without the flat elements 2 from the FIG. 1. In this embodiment, the support structure 3 is a frame, the frame has four motors 4 attached on it. The main frame has also attached eight profiles 19 with their surfaces on them that can flip over 180 degrees. As it is show in FIGS. 2, 3 and 4, the rotation mechanism further comprises gears (8, 9), wherein the gears (8, 9) are configured to transmit motion from the motors 4, which comprises a motor shaft having a gear 21, to the rotatable bodies 19, wherein the gears comprise also a Geneva mechanism 6, also called Geneva gears. The Geneva mechanism 6 may comprise a drive wheel 8 and a driven wheel 9. The main frame has attached two sets of gears (8, 9) and that get motion from the motors 4 and rotate 180 degrees the profiles 19. Finally, the main frame has two set of angular gears 5 that get motion from the other two motors 4 and move the windshield wipers 15. One of the motors is the motor that rotates the profiles 19 at an odd position (1a, 1c, 1e, 1g) with a set of gears (8, 9), axles (7, 11) and other mechanical parts. The other motor is the motor that rotates the profiles 19 and cleanable surfaces at even positions (1b, 1d, 1f, 1h) with another the set of gears (8, 9), axles (7, 11) and other mechanical parts. Another motor 4 moves a set of angular transmission gears 5 that move a first windshield wiper shown in FIG. 5. Another motor moves a set of angular transmission gears 5 that move the second windshield wiper 15. It is also contemplated the use of worm drive mechanism for the rotation of the rotatable bodies or windshield wipers. FIG. 5 depicts the system view from underneath. So, if the system in FIG. 1 flips over it is obtained the view of FIG. 5.

In the embodiment of FIG. 3 it is depicted a detailed view of the set of gears (8, 9) that is already shown in the top view of FIG. 2. The system comprises a timing belt 14, wherein the at least one timing belt 14 is connected to the gears (8, 9) and is configured to transmit the motion from the motors 4 to the gears (8, 9). The system further comprises belt tensioners 10 and guiding rolls 12 for tensioning and guiding, respectively, the timing belt 14. The system further comprises one or more axles (7, 11), and wherein the rotatable bodies 19 are attached or connected to the support structure 3 by means of the one or more axles (7, 11), preferably each rotatable body 19 being attached and rotatable by means of two of the axles (7, 11). The rotation mechanism of the system further comprises bearings, and wherein the axles (7, 11) are attached or connected to the support structure 3 by means of the bearings. It is also contemplated that the axles (7, 11) are attached or connected to the support structure 3 by means of bushings or self-lubricating bushings. The bushings or bearings may be inside a socket or holder 13. The FIG. 3 has two different views so that it can be better understood the position of every gear (8, 9), axle (7, 11), timing belt 14 and component of the system. A partial top view of a self-cleaning surface system in FIG. 3A and a side view in FIG. 3B. FIG. 3A shows the frame wherein all mechanical parts are attached. However, the mechanical parts may be attached to other types of support. The geometry of the shape of the profile 19 is shown in FIG. 7A. A first 1 and a second 20 cleanable surfaces are on top and on the bottom of the profile 19. The axles shown in FIG. 3 are for attaching the Geneva mechanism 6 for the rotation of the profiles 19. Those axles are attached on the frame with bearings. The motion from the motor's gears is transferred to the gears of the axles 11 with a timing belt 14. The gears (8, 9) are also part of a geneva mechanism 6. When a gear rotates by the belt 14, it moves also the Geneva gears 6 that rotate the axle 11 of the profile 19. The belt tensioners 10 are used for tensioning the timing belt 14. Some of the gears (8, 9) rotate the axles attached on the frame. Each profile 19 has attached one axle 11 that has gears and one axle 7 that does not have any gears (8, 9) or Geneva mechanism 6 on them. Therefore, there are axles 7 that are only supporting axles. There are guiding rolls 12 for guiding the timing belt 14. FIG. 3B shows the angular transmission gear 5 that gets motion from motor 4 and the angular gears 5 move a windshield wiper shaft for the rotation of the windshield wipers 15.

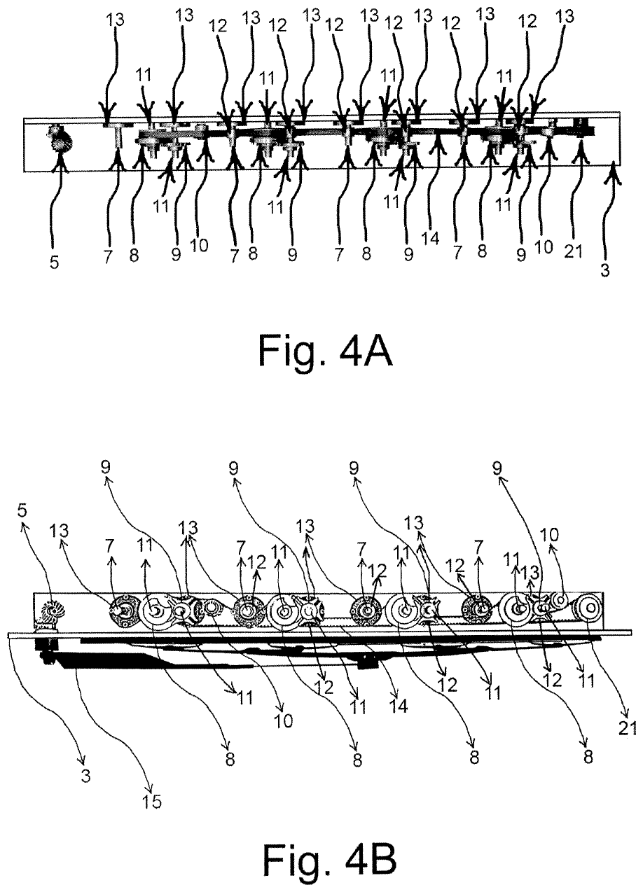

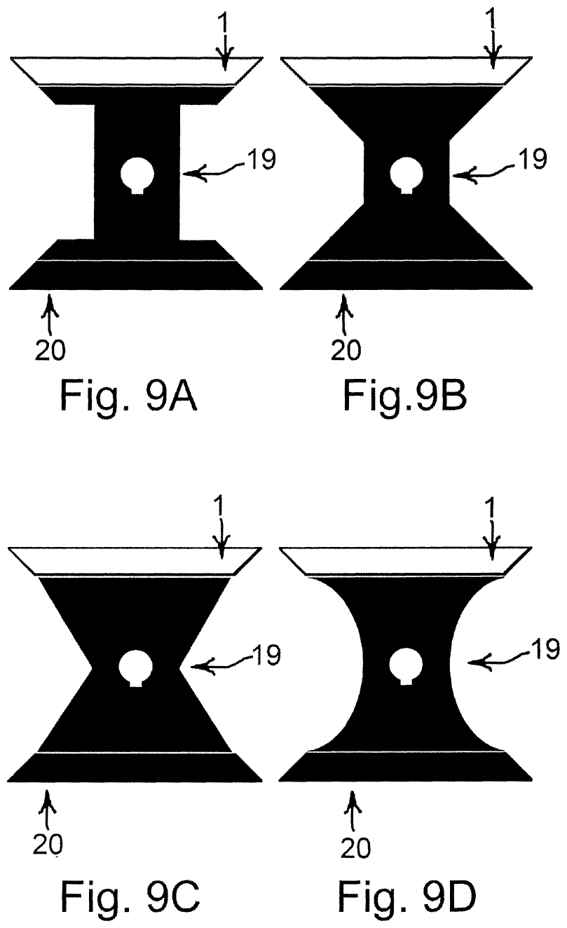

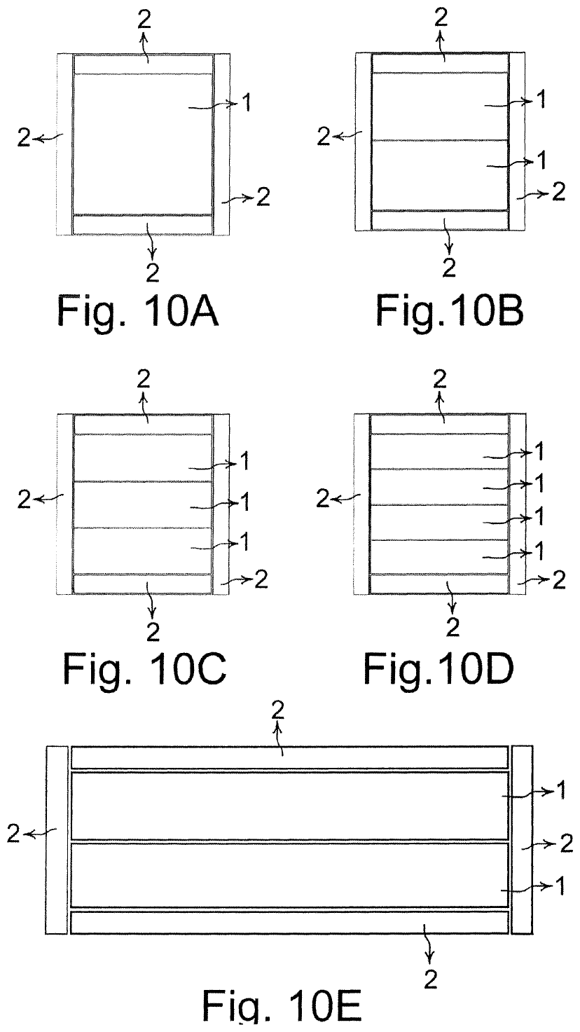

FIG. 5 is the bottom view of an embodiment of the self-cleaning surface system. It is depicted the frame, the cleanable surfaces 20 facing the second direction and the windshield wipers 15 of the cleaning mechanism of the present invention. FIG. 6 is divided by FIG. 6A and FIG. 6B and depicts two different views of the system case 16. The FIG. 6A shows a top view of a system case 16 for the system shown in FIG. 1. So, this is an embodiment of a case 16 in which the system fits. In this embodiment the case comprises a floor sink 17, the latter being used for the drainage of the cleaning fluid of the system. It is shown the main body of the case 16, shows a floor sink 17 and a spray jet washer nozzle 18. FIG. 6B is a perspective top left side view for better understanding of the shape of that case 16 that the system fits in. That case 16 can be adapted to the same level with the floor so the eight surfaces 1 that flip over will be on the same level as the rest of the floor. If we want to have a mobile system, for example a mobile public restroom floor for an event, for a concert etc., then the case 16 with the system can be above the main floor. It will be one step higher. FIG. 7 depicts the side view of the geometrical profile 19 that may be used. FIG. 7 is divided on FIG. 7A and FIG. 7B. FIG. 7A shows a side view of one of the eight profiles 19 that rotate 180 degrees. The two surfaces (1, 20) are on a profile 19. The FIG. 7 has two different views so we can understand better how the side of the profiles 19 looks with two cleanable surfaces on top and bottom. Those surfaces can be made by any material. It can be ceramic, granite, glass, plexiglass, stone, metal, plastic, wood, synthetic or combinations thereof or any material can be shaped according the dimension needed. The cleanable surfaces may also be made of hydrophobic materials. FIG. 7B is a side view of eight profiles 19. FIG. 8 depicts a side view of the eight profiles 19 and the sequence of rotation that follows during the operation. FIG. 8 is divided of eight lines, FIGS. 8A, 8B, 8C, 8D, 8E, 8F, 8G, 8H and 8I. FIG. 8A shows the eight profiles 19 without any motion. FIG. 8B, FIG. 8C, FIG. 8D and FIG. 8E shows the profiles 19 at even positions (1b, 1d, 1f, 1h) that flip over 180 degrees and the profiles 19 at odd positions (1b, 1d, 1f, 1h) stay still. The FIG. 8F, FIG. 8G, FIG. 8H and FIG. 8I show the profiles 19 at odd positions (1b, 1d, 1f, 1h) that flip over 180 degrees and the profiles 19 at even positions (1b, 1d, 1f, 1h) stay still. So, FIG. 8I depicts all surfaces that have flipped over 180 degrees. This is one cycle. The top surfaces 1 may flip over 180 degrees following this sequence of rotation, although other sequences of rotation are contemplated. When the top surfaces 1 are dirty the system flips over odd and even surfaces 180 degrees till all eight surfaces flip over. So, the dirty surfaces 1 are on bottom side now and the clean surfaces 20 from bottom are on top. When the eight dirty surfaces of this embodiment are in position 180 degrees on bottom side, a cleaning mechanism starts cleaning them and keep them stand by till the next 180 degrees rotation. The cleaning mechanism in FIG. 2 comprises two motors 4 and two sets of angular transmission gears 5. The embodiment also comprises two wipers (15) of the windshield type, as shown FIG. 3B and FIG. 4B and a windshield wiper spray jet washer nozzle 18 in FIG. 6. The spray jet washer nozzle 18 uses water with cleaning and disinfecting agent for the cleaning of the dirty surfaces. The motion of the windshield wipers 15 alternates. When the wiper moves from 0 to 90 degrees and comes back to 0 the exact same time the wiper remains still. When the first wiper starts to operate, the spray jet washer nozzle 18 from FIG. 6 starts to spray water with cleaning agent on the dirty surfaces for a programed time. Then the second wiper moves from 0 to 90 degrees and comes back to 0 then the first wiper 15 remains still, and vice versa till the two windshield wipers 15 clean the surfaces and the operation software stops both. In every circumstance only one wiper 15 operates and the other remains still. After this phase the bottom surfaces are cleaned and stand by until the next 180 degrees rotation. FIG. 9 depicts some of the variants of different geometry profiles 19 that we can use in the system without facing any collision or rotation problem. FIG. 9 is divided to FIG. 9A, FIG. 9B, FIG. 9C and FIG. 9D. Those four FIG. depict the same top surfaces and the same bottom surfaces. The difference is on the geometrical shapes of the profiles 19. This geometry allows the profiles 19 to be close enough and flip over 180 degrees one by one without any collision problems. FIG. 10 is divided to FIG. 10A, FIG. 10B, FIG. 10C and FIG. 10D and FIG. 10E. Those five FIG. depicts some of the variants that can be used. FIG. 10A depicts a top view of an automatic self-cleaning surface system comprising one surface of a profile 19 that can rotate 180 degrees. There is one surface that can flip over and four flat elements 2 with surfaces that cannot rotate. FIG. 10B depicts a top view of an automatic self-cleaning surface system comprising two surfaces that can rotate 180 degrees. FIG. 10C depicts a top view of an automatic self-cleaning surface system comprising three surfaces that can rotate 180 degrees. FIG. 10D depicts a top view of an automatic self-cleaning surface system comprising three surfaces that can rotate 180 degrees. FIG. 10E depicts a top view of an automatic self-cleaning surface system comprising two surfaces that can rotate 180 degrees. The automatic self-cleaning surface system may comprise at least one surface that can rotate 180 degrees.

An embodiment of the present invention refers to an automatic self-cleaning surface system that may clean its own main surface which is divided to eight smaller surfaces 1 in FIG. 1. The shape of those surfaces is rectangle and are on a special geometrical profile 19. On the top side of the profile 19 is the cleanable surface 1 and on the bottom side of the profile 19 is another cleanable surface 20. So, all eight profiles 19 are next each other and are attached on the main frame, as shown in FIG. 2. The geometry of the profiles 19 may be one of the variants depicted in FIG. 9A, FIG. 9B, FIG. 9C and FIG. 9 D because this geometry allows the surfaces to be close enough to each other and rotate without a problem. We can also use other geometrical shapes similar to those. The vertical dimension of the profile 19 should be as small so it will allow the 180-degree rotation without colliding with the profile 19 next to it. In that way the even with the odd profiles 19 can turn 360 degrees on their axes without crushing each other. So, the geometrical shape of the profiles 19 and the specific sequence of rotations that the system follows is an important aspect that allows those profiles 19 with their surfaces, to rotate during the operation and flip over 180 degrees. In embodiments of FIG. 1, the activation mechanism may comprise a controller configured to control the rotation of the profiles 19 and the cleaning mechanism. The system also comprises an injector, which is not shown, wherein the injector is configured to regulate the fluid ejection, and wherein preferably the injector comprises one or more electric valves. In the embodiment of FIG. 1, when the eight top surfaces are dirty, sensors that know that there is no obstacle on top of the surface that can cause malfunction of the operation of the system may give a signal to start the automatic self-cleaning procedure. Although they are not shown, the system may one or more sensors configured to activate the cleaning of the cleanable surface or the rotation of the rotatable bodies. The sensors may be photosensors configured to detect any light variation caused from at least one element or user over the cleanable surfaces. In other embodiments, the sensors may be weight sensors configured to sense at least one element or user over the cleanable surfaces. According to other embodiment, it is contemplated that the sensors may also comprise motion cameras configured to sense at least one element or user over the cleanable surfaces. The system automatically starts to flip over 180 degrees the even surfaces. However, in other embodiments the system may be activated manually. The system may start to flip either odd or even number, or positions, of surfaces. If the system starts with the even numbers (1b, 1d, 1f, 1h), this is done by rotation of a first motor 4 as is shown in FIG. 2. The gear 21 gives motion to the timing belt 14 and the belt 14 moves the geneva mechanism 6 with the gears (8, 9) till the 180 degrees is completed. Afterwards, the system automatically, or a user manually, starts flipping over 180 degrees the odd surfaces (1a, 1c, 1e, 1g). In FIG. 2, this can be done by rotation of the other set of gears (6, 8) and the second motor 4, as shown in FIG. 2. The gear (6, 8) gives motion to the timing belt 14, as shown in FIG. 3 and the belt 14 moves the geneva mechanism 6 with the gears (8, 9) and the Geneva 6 till the 180 degrees completed. The geneva mechanism 6 can lock the profiles 19 in position 0 and 180 degrees without the need of a locking system for those profiles 19. We can do it and without the geneva mechanism 6 with normal gears (8, 9) but the Geneva gears 6 provide a locking system so the profiles 19 will stay in position 0 and 180 degrees. If the odd surfaces (1a, 1c, 1e, 1g) start the rotation first and the even surfaces (1b, 1d, 1f, 1h) second or vice versa isn't important because the system has the same operation. So, it may be adjusted by programming the operation software. So, when the dirty surfaces are on the bottom side a cleaning mechanism starts cleaning them. The windshield wiper spray jet washer nozzle 18 in FIG. 6 starts spraying fluid with cleaning and disinfecting agent on the dirty surfaces. At the same time the motor 4 and the set of angular transmission gears 5 depicted in FIG. 2 give motion to the windshield wiper 15 and moves from 0 to 90 degrees and back to 0 degrees. At the same time the other windshield wiper stays still. Then the second motor 4 and the set of angular transmission gears 5 give motion to the windshield wiper 15 and move from 0 to 90 degrees and back to 0 degrees. At the exact same time the other windshield wiper 15 stays still. After a programed time of alternate operation of the windshield wipers 15 parallel with fluid spraying and cleaning agent, the surfaces are clean. The system stops the operation and stays stand by, until the next 180 degrees rotation of the clean surfaces from bottom to top.

While preferred materials for elements have been described, the present invention is not limited by these materials. All kind of materials may comprise some or all the elements of the apparatuses in various embodiments of the present invention. Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

1. A self-cleaning surface system, comprising:
rotatable bodies;
a support structure supporting the rotatable bodies, wherein the rotatable bodies are configured to rotate with respect to the support structure about a corresponding rotation axis, said rotatable bodies having a corresponding cleanable surface which is parallel to the corresponding rotation axis and being configured to rotate together with the corresponding rotatable body, from facing a first direction to facing a second direction and vice versa, the first direction being opposite to the second direction;
a rotation mechanism that is configured to rotate the rotatable bodies;
a cleaning mechanism comprising a cleaning fluid ejection mechanism; and
an activation mechanism configured to activate the cleaning fluid ejection mechanism when each cleanable surface faces the second direction, wherein the cleaning fluid ejection mechanism when activated is arranged to eject a cleaning fluid towards said one or more cleanable surfaces when the latter face the second direction; wherein,
the rotatable bodies are arranged adjacent to each other, wherein along a geometrical cross section of each rotatable body, said geometrical cross section being incident and perpendicular to the cleanable surfaces, and the rotatable bodies comprise recesses configured to permit the cleanable surfaces of each rotatable body, when the rotatable bodies rotate, to at least partially fit in or pass through the recesses of the adjacent rotatable bodies.

2. The self-cleaning surface system according to claim 1, wherein each rotatable body comprise an additional cleanable surface opposite to the corresponding cleanable surface, wherein the additional cleanable surface is configured to face the second direction when the corresponding cleanable surface faces the first direction and vice versa, and wherein the cleaning fluid ejection mechanism when activated is arranged to eject the cleaning fluid towards whichever of the cleanable surface of the rotatable bodies faces the second direction.

3. (canceled)

4. The self-cleaning surface system according to claim 1, wherein the rotation mechanism further comprises one or more motors configured to rotate the rotatable bodies, and wherein each rotatable body is at a corresponding odd or even position of a sequence of positions, each even position being adjacent to a corresponding odd position of the sequence.

5. The self-cleaning surface system according to claim 4, wherein the rotation mechanism comprises two motors, and wherein one of the two motors is configured to rotate the rotatable bodies which are at the corresponding odd positions and the other motor is configured to rotate the rotatable bodies which are at the corresponding even positions.

6. The self-cleaning surface system according to claim 5, wherein the two motors are configured to rotate first all the rotatable bodies at the corresponding odd positions and then rotate all the rotatable bodies at the corresponding even positions, or vice versa.

7. The self-cleaning surface system according to claim 4, wherein the rotation mechanism further comprises one or more worm drive mechanisms, wherein the one or more worm drive mechanisms are configured to transmit the motion from the motors to the rotatable bodies.

8. The self-cleaning surface system according to claim 4, wherein the rotation mechanism further comprises gears, wherein the gears are configured to transmit motion from the motors to the rotatable bodies, and preferably the gears being Geneva gears.

9. The self-cleaning surface system according to claim 8, wherein a transmission chain is connected to the gears and is configured to transmit the motion from the motors to the gears.

10. The self-cleaning surface system according to claim 8, further comprising at least one timing belt, wherein the at least one timing belt is connected to the gears and is configured to transmit the motion from the motors to the gears.

11. The self-cleaning surface system according to claim 10, further comprising belt tensioners and guiding rolls for tensioning and guiding, respectively, the timing belt.

12. The self-cleaning surface system according to claim 1, further comprising one or more axles, wherein the rotatable bodies are attached to the support structure by means of the one or more axles, preferably each rotatable body being attached and rotatable by means of two of the axles.

13. The self-cleaning surface system according to claim 12, wherein the rotation mechanism further comprises bushings or bearings, and wherein the axles are attached to the support structure by means of the bushings or bearings.

14. The self-cleaning surface system according to claim 1, wherein the support structure is a frame.

15. The self-cleaning surface system according to claim 1, wherein the cleaning fluid is a cleaning liquid.

16. The self-cleaning surface system according to claim 1, wherein the cleaning fluid is steam.

17. The self-cleaning surface system according to claim 1, wherein the cleaning ejection mechanism comprises one or more spray nozzles configured to spray the cleaning fluid over the cleanable surfaces that face the second direction, and wherein preferably the cleaning fluid comprises cleaning and/or disinfecting agents.

18. The self-cleaning surface system according to claim 1, wherein the cleaning mechanism further comprises one or more wipers configured to clean the cleanable surfaces that face the second direction, wherein preferably each wiper is rotatable by 90 degrees.

19. The self-cleaning surface system according to claim 18, further comprising one or more motors connected to the wipers by angular gears and configured to rotate said wipers.

20. The self-cleaning surface system according to claim 1, further comprising one or more wheel brushes configured to clean the cleanable surface facing the second direction.

21. The self-cleaning surface system according to claim 1, further comprising a case in which the system fits.

22. The self-cleaning surface system according to claim 21, wherein the case comprises a floor sink.

23. The self-cleaning surface system according to claim 1, wherein the one or more cleanable surfaces are made of a material selected from the group consisting of ceramic, granite, glass, plexiglass, stone, metal, plastic wood, synthetic, organic or combinations thereof.

24. The self-cleaning surface system according to claim 1, wherein the activation mechanism comprises a controller configured to control the rotation of the rotatable bodies and the cleaning mechanism.

25. The self-cleaning surface system according to claim 1, wherein the activation mechanism comprises an injector, wherein the injector is configured to regulate the liquid ejection, and wherein preferably the injector comprises one or more electric valves.

26. The self-cleaning surface system according to claim 1, further comprising one or more sensors configured to activate the cleaning of the cleanable surface or the rotation of the rotatable bodies.

27. The self-cleaning surface system according to claim 26, wherein the sensors are photosensors configured to detect one or more light variations caused from at least one element or user on top of the cleanable surfaces.

28. The self-cleaning surface system according to claim 26, further comprising weight sensors configured to sense weight variations caused by at least one element or user on top of the cleanable surfaces.

29. The self-cleaning surface system according to claim 1, further comprising motion cameras configured to detect at least one element or user on top of the cleanable surfaces.

30. The self-cleaning surface system according to claim 1, wherein the system is configured to be activated manually.

31. The self-cleaning surface system according to claim 1, wherein the system is configured to activate the rotation of the rotatable bodies and the cleaning of the cleanable surfaces automatically.

32. The self-cleaning surface system according to claim 1, further comprising one or more flat elements around the rotatable bodies, wherein the one or more flat elements cover the rotation mechanism and the support structure.

33. A floor comprising a self-cleaning surface system as described in claim 1.

34. A method for the self-cleaning of the surfaces of a system which is according to claim 1, the method comprising the steps of:
rotating the rotatable bodies 180 degrees from facing a first direction to facing a second direction, and, when the rotatable bodies rotate, the recesses of the rotatable bodies permit the cleanable surfaces of each rotatable body to at least partially fit in or pass through the recesses of the adjacent rotatable bodies;
activating the cleaning mechanism once all the rotatable bodies face the second direction; and
cleaning the one or more cleanable surfaces facing the second direction by ejecting the cleaning substance towards said one or more cleanable surfaces.

35. The method according to claim 34, wherein each rotatable body of the self-cleaning surface system comprises an additional cleanable surface opposite to the corresponding cleanable surface, wherein the additional cleanable surface faces the second direction when the corresponding cleanable surface faces the first direction and vice versa, and wherein the cleaning fluid ejection mechanism when activated ejects the cleaning fluid towards whichever of the cleanable surface of the rotatable bodies faces the second direction.

36. The method according to claim 34, wherein the self-cleaning surface system further comprises a plurality of rotatable bodies and wherein the rotation mechanism further comprises one or more motors configured to rotate the rotatable bodies, and wherein each rotatable body is at a corresponding odd or even position of a sequence of positions, each even position being adjacent to a corresponding odd position of the sequence, and wherein the step of rotating rotatable bodies 180 degrees from facing a first direction to facing a second direction is first made over rotatable bodies at the corresponding odd positions and then over rotatable bodies at the corresponding even positions or vice versa.

37. The method according to claim 34, wherein the cleaning mechanism of the self-cleaning surface system further comprises one or more wipers configured to clean the cleanable surfaces that face the second direction, wherein preferably each wiper is rotatable by 90 degrees, and wherein the step of cleaning the one or more cleanable surfaces facing the second direction by ejecting the cleaning fluid towards said one or more cleanable surfaces is preceded or followed by a step of rotating the wipers over the cleanable surfaces facing the second direction.

38. The method according to claim 34, wherein the self-cleaning surface system further comprising sensors configured to detect at least one element on the one or more cleanable surfaces facing the first direction, and wherein the method comprises a first step of detecting at least one element on the cleanable surface facing the first direction.

39. The method according to claim 34, wherein the steps are started automatically by the system.

40. The method according to claim 34, wherein the steps are started manually.
